(19) United States
(12) Patent Application Publication
(10) Pub. No.: US 2015/0089693 A1
(43) Pub. Date: Mar. 26, 2015

(54) MULTI-RESONANT DETECTION SYSTEM FOR ATOMIC FORCE MICROSCOPY

(71) Applicant: UT-Battelle, LLC, Oak Ridge, TN (US)

(72) Inventor: Stephen Jesse, Knoxville, TN (US)

(21) Appl. No.: 14/460,879

(22) Filed: Aug. 15, 2014

Related U.S. Application Data
(60) Provisional application No. 61/881,573, filed on Sep. 24, 2013.

(51) Int. Cl. G01Q 10/00

(52) U.S. Cl. CPC G01Q 10/00
USPC 850/1

(57) ABSTRACT

A multi-resonant detection system (MRD) chip comprises an AFM tip, a cantilever, and resonator members separately positioned relative to the cantilever and tip. The chip may be fabricated from a silicon wafer. Frequency of tip motion is detected or actuated by displacement of resonator members. A rigid member, which is coupled to the chip by flexible members, coupled to the resonator members and rigidly coupled to the cantilever, enables tip motion. Resonator members include an array of discrete resonator bars, a single resonator bar or a continuous membrane which resonates at a continuous range of frequency. Tip motion is detected by measuring displacement of the resonator members using angle of light reflection, capacitance, piezo-resistive or piezo-strain techniques. Tip motion is actuated using displacement of the resonator members and capacitive, piezo-strain or piezo-resistive techniques. Resonator members may be encased by cover plates and/or hermetically sealed for measurements in a liquid medium.

### CROSS REFERENCES TO RELATED APPLICATIONS

This patent application makes reference to and claims priority to U.S. Provisional Patent Application Ser. No. 61/881,573, filed on Sep. 24, 2013, which is hereby incorporated herein by reference in its entirety.

### STATEMENT REGARDING FEDERALLY FUNDED RESEARCH AND DEVELOPMENT

This invention was made with government support under Contract No. DE-AC05-00OR22725 between UT-Battelle, LLC. and the U.S. Department of Energy. The government has certain rights in the invention.

### BACKGROUND OF THE INVENTION

1. Technical Field

The present disclosure relates to atomic force microscopy and more specifically to a multi-resonant detection system for atomic force microscopy.

2. Related Art

An atomic force microscope may include a cantilever with a sharp tip (probe) which may be used to scan the surface of a specimen or sample material. The cantilever may be made of silicon and/or silicon nitride, for example, with a tip radius of curvature which may be on the order of nanometers. The cantilever and tip may be part of an atomic force microscopy (AFM) chip fabricated from a single silicon wafer. In instances when the tip and the specimen surface are brought into close proximity, interaction forces between the tip and the sample may cause deflection of the cantilever. Static and dynamic forces at work on the tip may be detected based on the deflection. Sensitivity of the detection process may be greatly enhanced in instances when the cantilever is made to operate on resonance, and therefore act as a mechanical amplifier of tip motion. Characteristics of the cantilever, such as resonance, may be determined by the size and shape of the cantilever and may not be adjustable while taking measurements. These characteristics may affect efforts to measure frequency dependent parameters of a specimen since the characteristics of the cantilever determine which frequencies can be amplified.

In AFM measurements, the cantilever and tip may measure aspects of the surface of a specimen. The cantilever and tip may be conductively coated and a bias may be applied to the tip. In a standard AFM apparatus, the cantilever may be flexible and may extend to the tip which may mechanically or physically touch the specimen surface. Some measurements may be conducted to determine whether, in instances when a bias is applied to the tip, how that bias changes the specimen surface in a local area. For example, the applied bias may change the height of the surface or it might change the mechanical, electrical or other material properties of the surface the sample. Also, in the case of a ferroelectric specimen, the polarization of an electric field in the specimen may change direction. For example, when an external electric field is applied to an ionically conductive material by the AFM tip, the ion concentration and local charge distribution inside or on the surface of the material may change. In this regard, battery materials may be studied using a biased AFM tip. In some AFM systems, measurements may be taken in a liquid either with or without applied bias, where the cantilever and tip may oscillate within the liquid. In order to do very sensitive measurements of a material in standard AFM, the cantilever may be run on resonance, for example, at one or more modes of the cantilever and tip. When the cantilever is driven with a force at a certain frequency or mode, it will shake or vibrate with much greater amplitude than at other frequencies. The presence of liquid, stray electric or magnetic fields and changes in mass of the tip (due to tip breaking or picking up of material) may have an effect on the dynamic characteristics of the AFM cantilever and these effects may be accounted for during analysis of the AFM results.

### BRIEF SUMMARY OF THE INVENTION

Disclosed are several examples of a multi-resonant detection system and method for making atomic force microscopy measurements. An atomic force microscopy (AFM) chip may comprise an AFM tip, a cantilever which is mechanically coupled to the AFM tip and one or more resonator members. The one or more resonator members may be positioned separately in the AFM chip relative to the cantilever and the AFM tip. Frequency of motion of the AFM tip and the cantilever may be detected by one or more of the resonator members. Also, motion of the AFM tip and the cantilever may be actuated by the one or more resonator members.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. Non-limiting and non-exhaustive descriptions are described with reference to the following drawings. The components in the figures are not necessarily to scale, emphasis instead being placed upon illustrating the principles of the invention. Moreover, in the figures, like referenced numerals designate corresponding parts throughout the different views.

FIG. 1 illustrates an oblique view of a multi-resonant detection system chip for atomic force microscopy.

FIG. 2 illustrates a front oblique view of detection and amplification apparatus in a multi-resonant detection system chip for atomic force microscopy.

FIG. 3 illustrates an isolated front oblique view of detection and amplification apparatus in a multi-resonant detection system chip for atomic force microscopy.

FIG. 4 illustrates an isolated front oblique view of detection and amplification apparatus during resonator excitation at a particular frequency in a multi-resonant detection system chip for atomic force microscopy.

FIG. 5 illustrates a detection and amplification apparatus comprising a continuous membrane resonator.

FIG. 6 illustrates an exploded oblique view of detection and amplification apparatus in a multi-resonant detection system chip for atomic force microscopy including top and bottom cover plates.

FIG. 7 is a frequency plot demonstrating how six resonator bars in a multi-frequency detection system may respond over a wide range of frequencies.

FIG. 8 illustrates a multi-resonant detection system chip within an atomic force microscopy test set-up.

### DETAILED DESCRIPTION OF THE PREFERRED EMBODIMENTS

A multi-resonant detection system for atomic force microscopy (AFM) may comprise a chip fabricated by photolithographic, micro- or nanofabrication, and machining manufacturing techniques. The chip may be made of one or more materials or multiple layers of materials, which are suitable for making micro-mechanical devices, for example, silicon, silicon oxide, silicon nitride, polydimethylsiloxane (PDMS), gold, platinum, titanium, and carbon. In some systems, the chip may be fabricated by many of the same techniques that are used in standard AFM chip manufacturing. The multi-resonant detection AFM chip may include an AFM tip which extends from a rigid or non-resonant cantilever where the cantilever may act as an acoustic, force, or displacement transmission line to one or more remote resonators or an array of resonators, for example. In this regard, the non-resonant cantilever may be interactively coupled to the one or more remote resonators. In some systems, a resonator array may resemble a xylophone and may include resonator bars of varying length, and therefore varying resonances. In some systems each of the resonator bars may be connected or clamped at both ends to more rigid members of the multi-resonant detection AFM chip. In other systems each resonator bar may be clamped at one end while the other end is free to vibrate. In some systems, motion of the resonator bars may be detected using laser deflection and a photodetector or an interferometer, for example. However, by positioning the resonator bars away from the tip and cantilever, various other displacement detection schemes may be utilized, for example, capacitance, piezo-strain, piezo-resistive and other displacement detection methods. The resonators or resonator bars are not limited to having a bar shape or any other specific shape and may have any suitable shape or shapes, for example, wires or tubes. A resonator bar may be referred to as a resonator or a resonator member, for example. Additionally, the resonator bars may be designed to work as actuators where they may be used to drive tip and cantilever motion with cleaner drive signals than currently available methods. Although the design may include resonator bars of varying length, a similar effect may be achieved by varying other aspects of the resonators, for example, the resonator bars may have the same length, but their effective masses may vary. For example, in some systems, the bars may be thicker in a small region at the center of the bars. The system is not limited with respect to any specific shape of the resonators and any suitable method of varying the resonance among the resonators may be utilized.

The multi-resonant AFM detection system may enable amplification of forces or displacements which are detected by the AFM tip over a broad range of frequencies. Unwanted external effects on cantilever dynamics, such as stray electric fields and liquid environments may be significantly reduced. Moreover, mechanical tip oscillations may be cleanly driven without the use of a piezo actuator and alternative means to detect tip deflection other than optical beam deflection are provided.

The multi-resonant AFM detection system may rely on the resonator bars rather than the AFM cantilever to provide mechanical amplification of the tip motion. In this regard, the mechanical amplification process may be moved further away from the AFM tip to a more protected region on the AFM chip. In some systems an array of mechanical resonators may be utilized, where the array may be designed to resonate over a broad range of discrete frequencies. Alternatively, a continuous resonator membrane may be used to provide a more continuous range of resonant frequencies.

As a result, many deleterious effects which may be imposed on an AFM amplification process by forces in the local environment of the tip and cantilever, may be avoided. For example, the local effects due to a liquid environment, stray electric and magnetic fields and changes in mass of the tip or cantilever (for example, due to the tip breaking or picking up material) that may impact dynamic characteristics of an AFM cantilever may be reduced or eliminated. Moreover, the multi-resonant design disclosed herein may enable significant amplification in any suitable region of the frequency spectrum and may provide better ways for detection in addition to laser deflection.

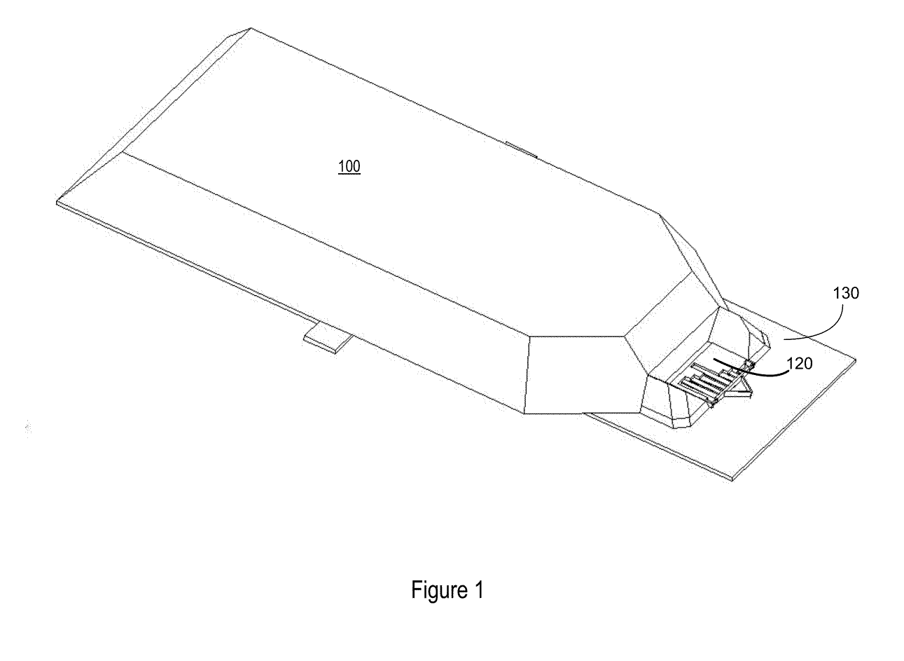

Now turning to the figures, FIG. 1 illustrates an oblique view of a multi-resonant detection system (MRD) chip 100 for atomic force microscopy (AFM) including a detection and amplification portion 120 of the chip 100. Also shown in FIG. 1 is a specimen material 130 which may be referred to as a sample.

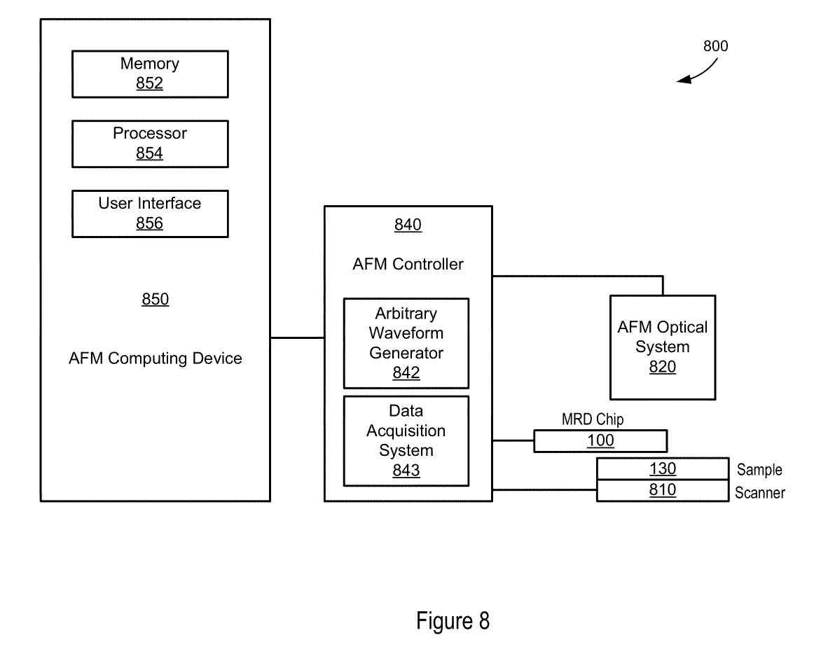

The MRD chip 100 may be fabricated from a silicon wafer. Photolithography and machining may be utilized to shape the chip. The MRD chip 100 may be a continuous, solid and/or single piece of silicon wafer that may include the detection and amplification portion 120. The detection and amplification portion 120 may comprise apparatus that senses or detects forces or physical changes in the specimen material 120. Also, the detection and amplification portion 120 of the MRD chip 100 may actuate tip motion to interact with the specimen 120. Operation of the MRD chip may be controlled by an atomic force microscope, for example, by controlling signals applied to the detection and amplification portion 120 for driving mechanical tip oscillations and/or by reading amplified vibration signals from the detection and amplification portion 120 of the MRD chip 100 to detect tip deflection (see FIG. 8).

The test system 100 may include additional components, such as additional circuitry, firmware and/or processing modules. For example, a controller module 7 and/or other modules in the test system 100 may comprise suitable logic, circuitry, interfaces and/or code that may be operable to determine and/or control bias waveforms and/or measure and compile results of measurements. Portions of test system 100 may be implemented by one or more integrated circuits (ICs) or chips.

In operation, the specimen material 130 may be positioned under the detection and amplification portion 120 so that properties of the surface of the specimen material 130 may be detected by the detection and amplification portion 120 and the results may be transmitted to a computing device in the atomic force microscope (see FIG. 8). The multi-resonant detection system (MRD) chip 100 may be referred to as an atomic force microscopy (AFM) chip.

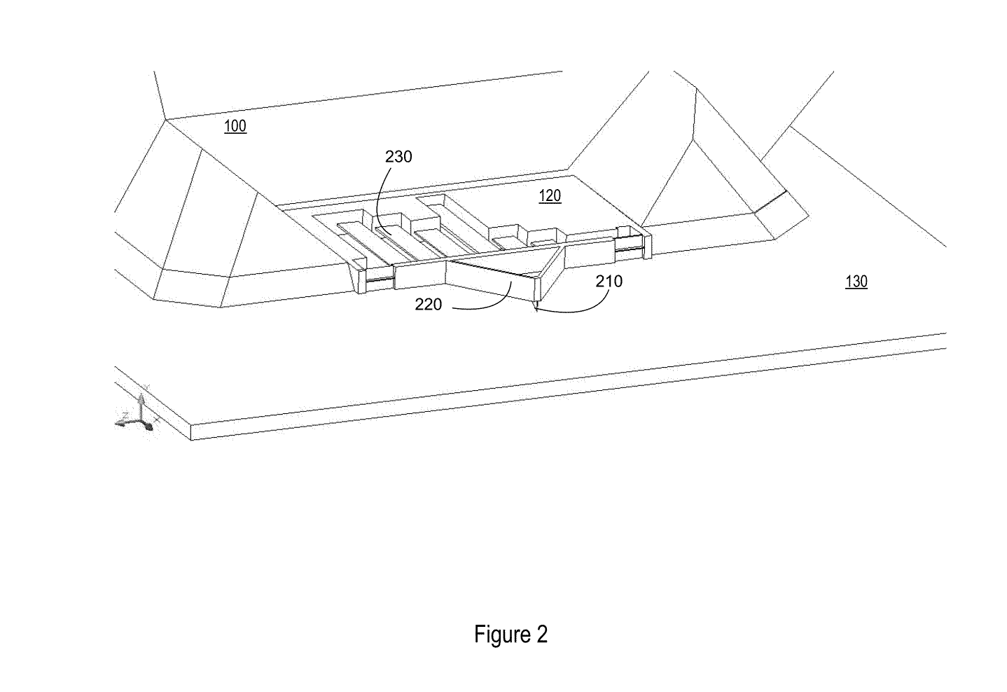

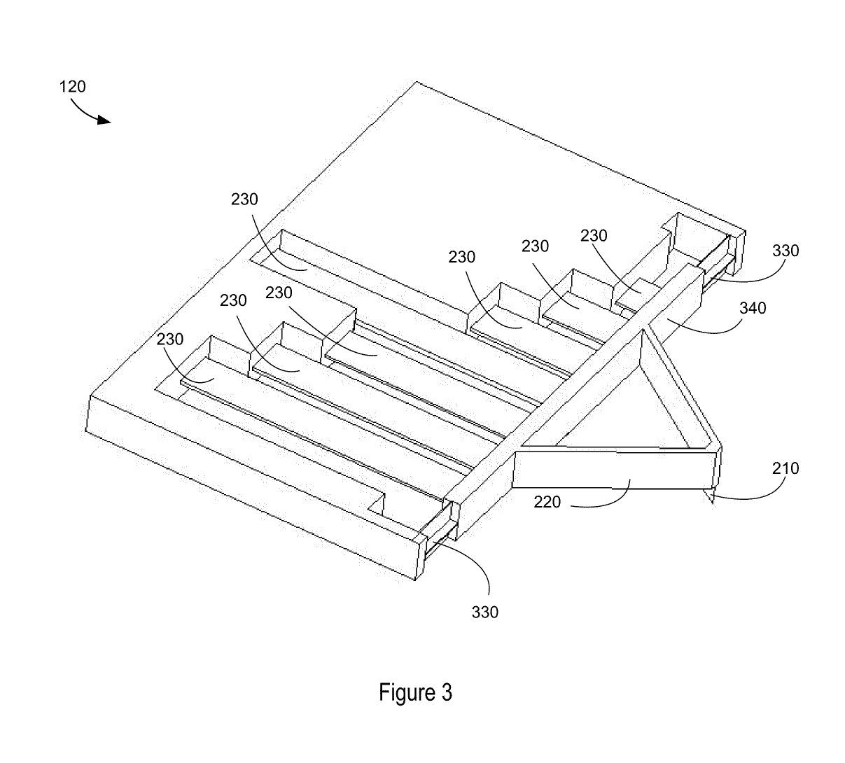

FIG. 2 illustrates an enlarged front oblique view of detection and amplification apparatus in a multi-resonant detection system chip for atomic force microscopy. Referring to FIG. 2, there is shown the multi-resonant detection system (MRD) chip 100 for atomic force microscopy (AFM) including the detection and amplification portion 120 and the specimen material 130 which may be referred to as a sample. Also shown are an AFM tip 210, a cantilever 220 and one or more resonator bars 230. The detection and amplification portion 120 may comprise the AFM tip 210, the cantilever 220 and the resonator bars 230, all of which are described with respect to FIG. 3. The AFM tip 210 may be positioned over the surface of the specimen material 130 and may detect changes in the specimen material. The AFM tip 210 may be referred to as the tip.

FIG. 3 illustrates an isolated front oblique view of the detection and amplification apparatus in a multi-resonant detection system (MRD) chip for atomic force microscopy. Referring to FIG. 3, shown are the detection and amplification portion 120, the AFM tip 210, the cantilever 220, and one or more resonator bars 230 of the MRD chip 100. Also shown are the rigid wall 340 and two flexible wall extensions 330.

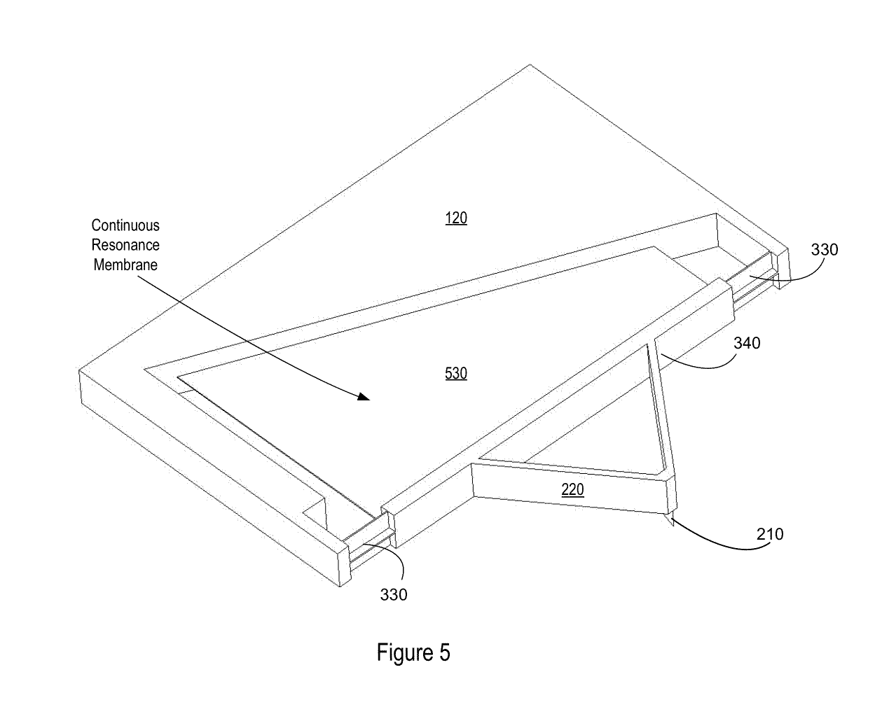

The detection and amplification portion 120 of the MRD chip 100 may include the AFM tip 210, the cantilever 220, one or more resonator bars 230, the rigid wall 340 and the flexible wall extensions 330, all of which may be included in the continuous, solid and/or single piece of silicon comprising the MRD chip 100. Although a plurality of resonator bars are shown in the FIGS. 1-4, some systems may comprise only one resonator or a continuous membrane resonator (described with respect to FIG. 5). The one or more resonator bars 230 may be referred to as a resonator, a resonator member, an array of resonators or resonator beams, for example.

The AFM tip 210 may extend from the cantilever 220. The cantilever 220 may be referred to as a non-resonating cantilever. In this regard, although a non-resonating cantilever 220 may resonate at one or more frequencies, a non-resonating cantilever 220 may not have significant resonance at the one or more frequencies employed in the multi-resonant detection methods described herein. For example, the cantilever 220 may not resonate at a frequency matching the resonant frequencies of the one or more resonator bars 230 or of the continuous resonator membrane 530 (described with respect to FIG. 5). A benefit of using a non-resonating cantilever 220 is that motion due to resonance of the cantilever 220, the tip 210 and/or the rigid wall 340, may not interfere with the multi-resonant detection system 100 operation or analysis. However, the system is not limited in this regard and in some systems, the cantilever 220 may have resonance characteristics that affect the MRD system operation or analysis.

The cantilever 220 may be mechanically coupled to the rigid wall 340. The rigid wall 340 may be referred to as a rigid member or element of the MRD chip 100. In some systems, the tip 210, the cantilever 220 and the rigid wall 340 may comprise a rigid and/or non-resonant armature, such that they move together, for example, when driven by a force or when the AFM tip 210 is set in motion by the sample 130. A bias may be applied to the tip 210 and/or the cantilever 220, which may cause the tip 210, the cantilever 220 and the rigid wall 340 to shake or vibrate together. In this regard, the spatial orientation of the tip 210, the cantilever 220 and the rigid wall 340 may remain fixed relative to each other during the vibrations or rotations, for example. The rigid wall 340, the cantilever 220 and the tip 210 together may be referred to as an armature or frame, for example. The non-resonating characteristic of the cantilever 220 may be different than other types of AFM cantilevers which are generally flexible and may bend and/or vibrate at resonant frequencies resulting in mechanical amplification of tip motion in the cantilever. However, rather than amplifying the motion of the tip 210, the non-resonating cantilever 220 and rigid wall 340 may move together with the motion of the tip and may serve as an acoustical transmission line between the tip 210 and the one or more resonator bars 230 such that the tip 210 motion is transferred unamplified by the cantilever 220 and rigid wall 340 to the one or more resonator bars 230. In this regard, the one or more resonator bars 230 may be interactively coupled with one or more of the non-resonating cantilever 220 and the tip 210, for example, via the rigid wall 340.

In some systems, since the cantilever 220 need not be an excellent resonator, the cantilever 220 may be pliant enough to reduce tip to surface forces while enabling high frequency measurements to be performed in the resonator cavity by the resonator array 230. Furthermore, in some systems, the cantilever may be made to be very thin laterally and tall, similar to a fin to help reduce effects of added mass motion in liquids.

The flexible wall extensions 330 may be attached to the rigid wall 340 of the cantilever 220 and to a rigid wall of the MRD chip 100. The flexible wall extensions 330 may enable the rigid wall 340, the cantilever 220 and the tip 210 to move up and down or rotate, for example, when driven by a force from the resonator bars 230 or when the AFM tip 210 is set motion by the sample 130, for example. In some systems the flexible wall extensions 330 may be operable to twist, stretch, rotate or swing, for example, to accommodate motion in the rigid wall 340, the cantilever 220 and the tip 210 armature or to induce motion originating in the resonators 230 and imparted to the rigid wall 340, the cantilever 220 and the tip 210 armature. In this manner, the triangular cantilever 220 may be rigidly connected to the rigid wall 340 and weakly connected through a flexible membrane of the flexible wall extensions 330 to the rest of the MRD chip 100.

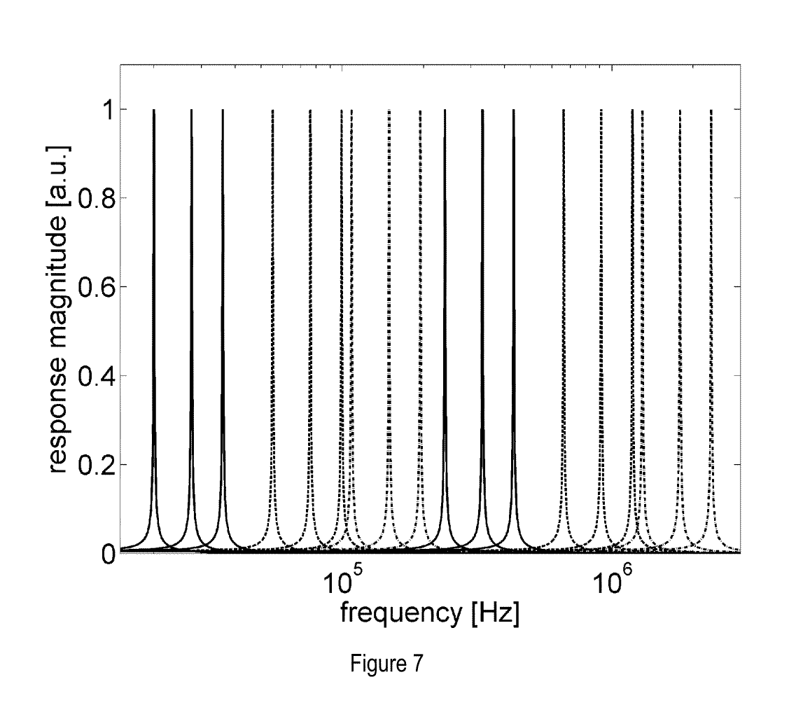

The one or more resonator bars 230 may be flexible elements in the MRD chip 100 and each may be operable to oscillate, shake or vibrate at one or more particular resonant frequencies or modes, depending on, for example, its size, shape and/or mass. The one or more resonator bars 230 may be rigidly attached or “clamped” to the rigid wall 340 and to a rigid or non-resonating wall or area of the MRD chip 100. In other systems, one end of each resonator bar may be rigidly attached or “clamped” to the rigid wall 340 while the opposite end may be detached and free to vibrate. The size, shape and/or mass of each resonator bar 230 may vary such that each of the one or more resonator bars 230 may be tuned to a different resonant frequency. In this manner, forces over a range of frequencies may be detected and amplified by the array of resonant bars 230 (described further with respect to FIG. 7). For example, longer bars may amplify lower frequency signals and relatively shorter bars may amplify higher frequency signals. Although the resonator bars 230 may be referred to as bars, the resonators or resonator bars are not limited to having a bar shape or any other specific shape and may have any suitable shape or volume. A resonator bar may be referred to as a resonator or resonator member, for example. An open space around the resonator bars 230 within the MRD chip 100 may be referred to as a resonator chamber or cavity. The resonator chamber may comprise a gas or may be encased to keep a liquid away from the resonators. Alternatively, the resonator chamber may hold a liquid environment for the resonators 230.

In operation, the flexible walls 330 at either end of the rigid wall 340 may allow the rigid wall 330, the cantilever 220 and the tip 210 to rotate or rock, for example, such that the tip 210 may be set into motion relative to the sample material 130. The tip 210 may oscillate, shake or vibrate, at least, up and down relative to the sample material 130 surface to tap or touch the surface. The rigid wall 340, the cantilever 220 and the tip 210 may rotate or rock together as one unit or armature, without internal resonance or amplification of the tip motion.

In some instances, the tip 210 may be set into motion by movement of the sample 130 or an external source such as shaking of the MRD chip 100, and the motion of the tip 210 may be transmitted via the cantilever 220 and the rigid wall 340 to one or more of the resonator bars 230 for detection. Thus, a force on the tip 210 that is transmitted through the triangle of the cantilever 220 to the rigid wall 330 may cause the entire tip 210, cantilever 220 and rigid bar 340 to rotate or move as a single unit. This displacement may cause one or more of the resonator bars 230 to vibrate at the frequency of the tip 210 and to amplify the tip motion. For example, in instances when the rigid wall 340, the cantilever 220 and the tip 210 move or vibrate at a particular frequency, one or more of the flexible resonator bars 230, which may have a resonant frequency or frequency mode corresponding to that particular frequency, may oscillate or vibrate at the resonant or modal frequency and may mechanically amplify the motion of the rigid wall 230, the cantilever 220 and the tip 210.

In other systems, one or more of the resonator bars may be driven to move or oscillate by an external source using electric, magnetic, thermal and/or photo-thermal effects. The motion of the one or more resonator bars 230 may cause the rigid wall 340, the cantilever 220 and the tip 210 to move or vibrate at a frequency corresponding to the resonant frequency or resonant frequencies of the one or more resonator bars 230. In this manner the one or more resonator bars 230 may actuate motion in the cantilever 220 and the tip 210.

In some systems the specimen material 130 may be set in motion and make contact with the tip 210 during a detection process. For example, the specimen material 130 may be mounted to a piezo-electric crystal. An alternating current (AC) voltage may be applied to the piezo-electric crystal which may cause the crystal to oscillate and vibrate the specimen material 130. The tip 210, the cantilever 220 and the rigid bar 340 may be set in motion as a response to the vibrations of the sample material 130 touching or tapping the tip 210, and may transmit the responsive motion and/or frequency to one or more of the resonating bars 230 according to the resonant and/or modal frequencies of the resonator bars 230. The responsive motion of the tip 210 may be influenced by the hardness of the surface of the specimen sample 130 or by forces between the specimen material 130 and the tip 210. In instances when a particular resonating bar 230 has a resonant frequency corresponding to the frequency of the responsive motion of the tip 210, the particular resonating bar 230 may oscillate at its resonant frequency.

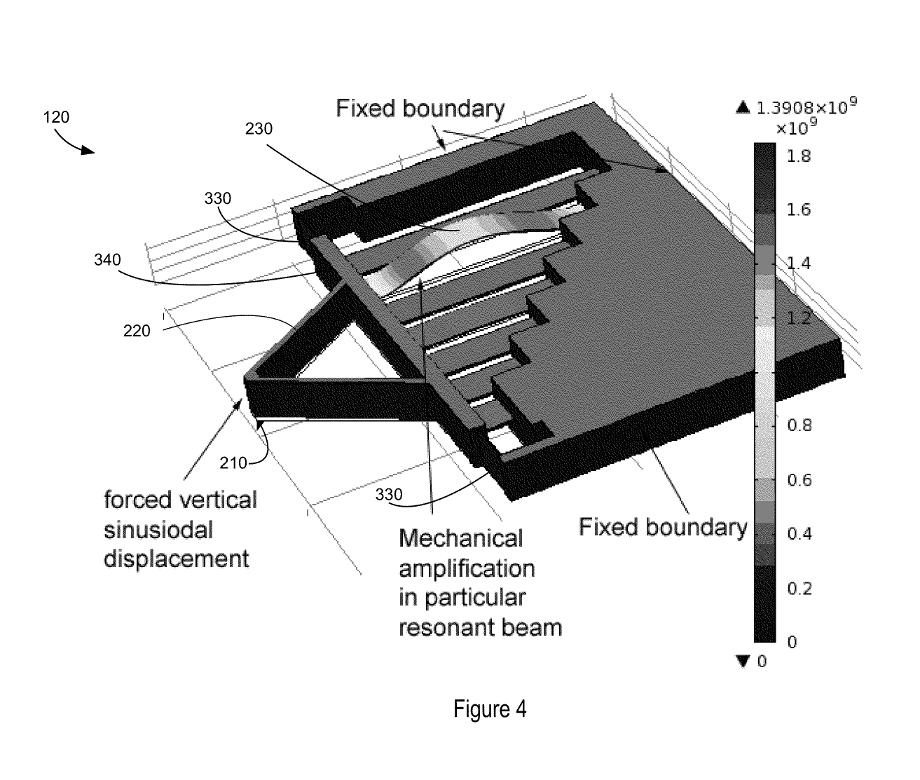

FIG. 4 illustrates an isolated front oblique view of detection and amplification apparatus during resonator excitation at a particular frequency in a multi-resonant detection system chip for atomic force microscopy. FIG. 4 comprises elements that are shown in FIG. 3, including the detection and amplification portion 120, the AFM tip 210, the cantilever 220, one or more resonator bars 230, the rigid wall 340 and two flexible wall extensions 330 of the MRD chip 100. However, FIG. 4 illustrates displacement of one of the resonator bars 230. The displacement be initiated as a response to motion of the tip 210, the cantilever 220 and the rigid wall 340, or may be initiated by stimulus applied to the resonator bars 230 and may be transferred to the rigid wall 340, the cantilever 220 and tip 120.

FIG. 4 comprises a model with fixed boundary conditions applied to the side and back edges of the model and a sinusoidal displacement applied to the end of the triangular cantilever 220. This model approximates AFM modes such as piezo-response force microscopy (PFM), electrochemical strain microscopy (ESM), or atomic force acoustic microscopy (AFAM) in which small displacements of the sample surface drive tip 210 motion. FIG. 4 illustrates an array of beam resonators 230 with one of the beams significantly deformed by the driving force applied to the end of the triangular cantilever 220. Though the displacement of the tip 210 may be small, the beam 230 motion may be quite significant in instances when the frequency of tip 210 motion matches the resonant frequency of one of the beams 230.

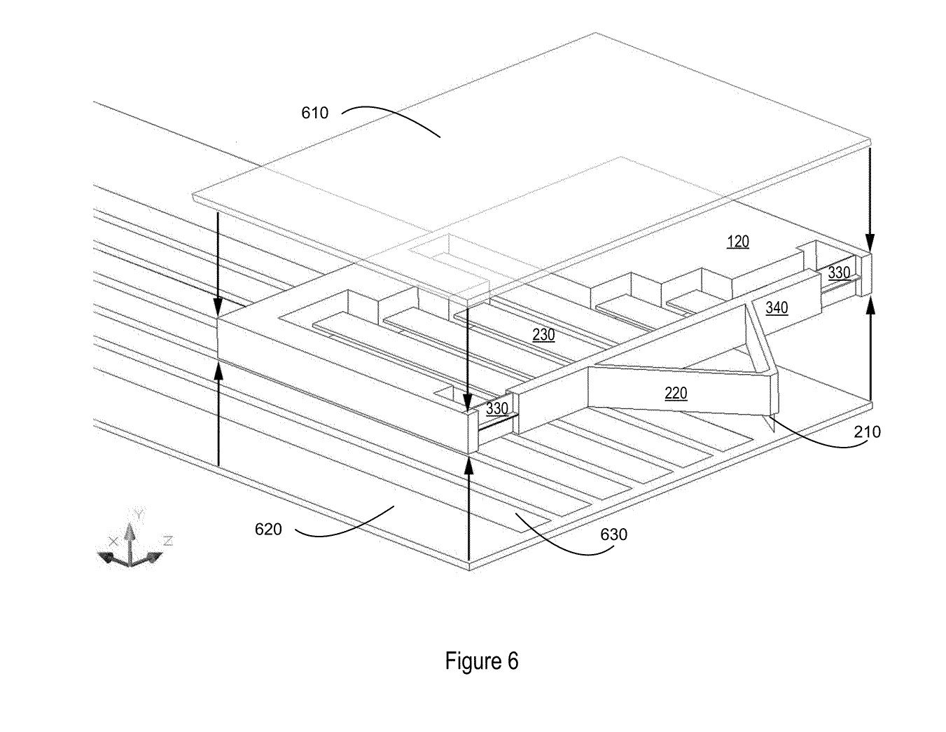

Motion and/or frequency of motion of the one or more resonant bars 230 may be detected in a variety of ways. For example, in some systems laser light may be shone on each of the resonator bars 230 such that motion of the resonator bars may cause changes in angle of reflections of the laser light. The changing reflection angle may be detected by a photosensor and motion and/or frequency of the tip 210 may be determined based on the laser reflections off of one or more particular resonant bars 230. In some systems, interferometry may be utilized to detect the resonator motion. In other systems, capacitance, piezo strain or piezo resistive methods, for example, may be utilized to detect motion of the flexible resonator bars 230 or to drive their motion, as described below with respect to FIG. 6.

FIG. 5 illustrates a detection and amplification apparatus for a multi-resonant detection system chip comprising a continuous resonator membrane. Referring to FIG. 5, there is shown a portion of the MRD chip 100 including the detection and amplification portion 120, the AFM tip 210, and the cantilever 220. Also shown is a continuous resonator membrane 530.

In some systems, the MRD chip 100 may have a continuous flexible resonator membrane 530 in place of the flexible resonator bars 230. In some systems, the continuous resonator membrane 530 may have a long triangular shape where the wide part of the triangle is resonant at lower frequencies and the narrow part is resonant at higher frequencies. However, the system is not limited with respect to the shape of the continuous resonator membrane 530. Since the membrane is continuous there may be more ways in which it can vibrate relative to the discrete resonator bars 230. The continuous resonator membrane 530 may yield a more continuous range of frequencies for detecting the motion of the tip 210 and cantilever 220 or for driving the tip and cantilever motion, as compared with fixed resonant frequency modes characteristic of discrete resonator bars 230. The continuous resonator membrane 530 may be referred to as a resonator member.

FIG. 6 illustrates an exploded oblique view of a detection and amplification apparatus in a multi-resonant detection system chip for atomic force microscopy including top and bottom cover plates. Referring to FIG. 6, the detection and amplification portion 120 of the MRD chip 100 including the AFM tip 210, the cantilever 220, the one or more resonator bars 230, the rigid wall 340 and the two flexible wall extensions 330 of the MRD chip 100 are shown. Also shown are a top cover plate 610, a bottom cover plate 620 and one or more electrodes 630. The electrodes 630 may be referred to as conductive strips, plates or a capacitor plate.

In some systems, the top cover plate 610 and/or bottom cover plate 620 may encase the resonators 230 in a cavity or chamber which may be partially open or may be hermetically sealed, for example.

In some systems, the bottom cover plate 620 may have electrodes 630 placed below the resonators 230 which may enable either detection or actuation of the resonators bars 230. The bottom cover plate 620 may be an encasing layer of the MRD chip 100. In some systems, the bottom cover plate 620 may be made of insulator material and may include one or more conductive strips or plates, for example, the electrodes 630. The one or more electrodes 630 may form one or more capacitors with corresponding resonator bars 230. In some systems, changes in capacitance between the electrodes 630 and corresponding resonator bars 230 may be used to either detect motion of the tip 210 or to drive motion of the tip 210.

In an exemplary system, one or more capacitors may be formed by one or more of the resonator bars 230 and the one or more electrodes 630 which may be positioned beneath the one or more of the resonator bars 230. For example, the one or more electrodes 630 may comprise a gold film 630 that may be placed beneath the encasing layer or bottom cover plate 620 on the bottom side of the MRD chip 100. A direct current (DC) and or alternating current (AC) voltage bias may be established between the electrode 630 and the one or more resonator bars 230. As a resonator bar 230 flexes up and down due to tip 210 and cantilever 220 motion at a certain frequency, the distance between the resonator bar 230 and a corresponding electrode 630 may vary and in turn the capacitance between the resonator bar 230 and the electrode 630 may vary. The varying capacitance may be measured to detect the motion and/or frequency of the motion of the tip 210. As a resonator bar 230 flexes up and down with respect to a plate 630 below it, the capacitance may vary and generate an AC signal at a frequency which corresponds to frequency of tip 120 and cantilever 220 motion in a response relative to the specimen 130.

Alternatively, the capacitor formed by the one or more electrodes 630 and one or more of the flexible resonator bars 230 above the electrodes 630 may be used to drive or generate motion in the cantilever 220 and tip 210, for example, using an AC bias signal applied to the capacitor. In this regard, an AC voltage may be applied between one or more of the resonator bars 230 and a corresponding one or more electrodes 630 beneath them. The applied AC voltage may create a changing force between those conductive plates. The AC bias voltage may oscillate at a resonant frequency of at least one of the resonator bars 230, the resulting force may cause at least one resonator bar 230 to vibrate or oscillate, which in turn may cause the cantilever 220 and tip 210 to move or shake relative to the specimen material 130 at the same or a corresponding frequency of the AC bias voltage. Furthermore, an AC signal may include any signal that changes in time and may or may not have multiple frequency components. For example, band excitation may be utilized that may include multi-frequency, non-sinusoidal excitation.

Alternatively, some systems may utilize piezo-electric or piezo-resistive methods for detection of tip 210 motion and/or for driving tip 210 motion. For example, the surface of one or more of the flexible resonator bars 230 may be coated with a piezoelectric or piezo-resistive material that may generate voltage or change resistivity when the film is deformed, for example, when the resonator bars flex up and down. In instances when one or more of the resonators 230 flexes up and down due to tip 210 and cantilever 220 motion, the flexure may cause pressure in the piezoelectric material and may generate AC voltage and/or current at a frequency corresponding to the frequency of the tip 210 and cantilever 220 motion. In some systems the piezoelectric coating may be placed on top of each of the flexible resonator bars 230 where pressure induces a bias across the material. In instances when an alternating current is applied to the piezoelectric coated resonator bars 230, the changing signal may cause the resonator bars to flex up and down at the frequency of the AC signal and the motion may be transferred to the cantilever 220 and tip 210.

In some systems, the top cover plate 610 and the bottom cover plate 620 may form hermetically sealed encasing layers that enclose the resonators 230 in a resonator cavity or chamber thereby enabling measurements in a liquid medium. In some systems, at least the top cover plate 610 may be made of a transparent material so that optical detection of a response in the resonator bars 230 may be made, for example, by detecting changing angles of laser light reflections at a photo detector. For example, the top cover plate 610 may be made of silicon nitride; however, the system is not limited in this regard.

In some systems the top cover plate 610 and/or the bottom cover plate 620 may form encasing layers which are made of a conductive material. The conductive encasing layers may be used to shield the resonators 230 from stray electric fields.

In some systems, one or more of the top cover plate 610, the bottom cover plate 620 and the electrodes 630 may be machined from the same silicon or semiconductor wafer as the rest of the MRD chip 100; however, the system is not limited in this regard. For example, in some systems one or more of the top cover plate 610, the bottom cover plate 620 and the electrodes 630 may be added to the MRD chip 100.

FIG. 7 is a frequency plot demonstrating how six resonator bars in a multi-frequency detection system may respond over a wide range of frequencies. The resonator bars 230 described with respect to FIGS. 1-5 may each respond in multiple flexural modes. Referring to FIG. 6, an exemplary response is shown for the first three modes of each of six resonators 230. The solid black lines represent resonance peaks of a first mode of oscillation in each of the six resonators 230. The dashed lines represent the resonance peaks of the second mode of oscillation in each of the six resonators and the dot-dash lines indicate the resonance peaks of the third mode of each of the six resonators. The amplitudes have been normalized to one.

FIG. 8 illustrates a multi-resonant detection system chip within an atomic force microscopy test set-up. Referring to FIG. 8, there is shown an AFM system 800 comprising the multi-resonant detection system (MRD) chip 100 for atomic force microscopy (AFM) and the specimen material 130, described with respect to FIGS. 1-7. Also included are a computing system 850, an AFM controller 840, an AFM optical system 820 and a scanning stage 810.

In some systems, the MRD chip 100 may comprise one or more traces, leads and or wires that that may be communicatively coupled to the AFM controller 840 and/or to the computing system 850.

The computing system 850 may comprise one or more processors 854, one or more memory devices 852 and/or one or more user interfaces 856, for example. The computing system 350 may comprise suitable logic, circuitry, interfaces or code that may be operable to store and/or execute instructions for controlling the AFM system 800 and/or collecting, analyzing and/or displaying AFM system 800 data. The computing system 850 may be utilized to configure and/or control one or more of the elements of the AFM system 800. The computing system 850 may be communicatively coupled to the AFM controller 840. In some systems, the computing system 850 and the controller 840 may be integrated in one device or in other systems, may be distributed in a plurality of devices. The AFM controller 840 may also be communicatively coupled to one or more of the MRD chip 100, the AFM optical system 820 and the scanning stage 810. The AFM controller 840 may comprise suitable logic, circuitry, interfaces or code that may be operable to send or receive control signals to one or more of the AFM chips 100, the AFM optical system 820 and the scanning stage 810. The AFM controller 840 may comprise an arbitrary waveform generator 842 for providing signals to the MRD chip 100, for example, to apply bias voltages to the MRD chip 100. The AFM controller 840 may be operable to actuate motion of the tip 210 by sending signals to the resonator bars 230 or to the continuous resonator membrane 530, for example, utilizing changes in capacitance, piezo-resistive or piezo-strain techniques. The AFM controller 840 may comprise a data acquisition system 843 that may be operable to convert received signals into data that can be stored in a memory device or utilized by a computer, for example, the one or more memory devices 852 and/or the AFM computing device 850. In some systems, the data acquisition system 843 may receive signals generated by detection of displacement of the resonator bars 230 or of the continuous resonator membrane 530. For example, the data acquisition system 843 may convert voltage signals received generated from measurements of light deflection, into numerical data.

In some systems, the sample 130 may be placed on the scanning stage 810. The scanning stage 810 may be operable to move the sample 130 relative to the tip 210 of the MRD chip 100 to enable testing of the sample 130 surface at various positions. For example, the scanning stage 810 may enable raster scanning of the sample 130 by the tip 210.

The AFM optical system 820 may comprise one or more devices that may be communicatively coupled to the controller 840 and/or the computing device 850. The one or more AFM optical system 820 devices may enable detection of changes in sample 130, detection of tip 210 deflection, data collection, observation of the MRD chip 110 and/or sample 130, or heating of the MRD chip 100 and/or the sample 130.

In one example, the AFM optical system 820 may comprise a laser, a lens and/or a photodetector or interferometer for measuring displacement or frequency of the resonator bars 230 or the continuous resonator membrane 530. In this regard, the laser may be aimed at the resonators 230 or 530 through the lens and changes in reflected beam angles may be measured in the photo detector and communicated to the AFM computing device 850 and/or the controller 840.

In another example, the AFM optical system 820 may comprise an optical microscope that may enable visual observation of the sample 130, the tip 210 and/or the cantilever 220. In some systems, the optical microscope may provide video images, for example, during testing of the sample 130.

In some systems, the AFM optical system 820 may comprise a laser that may be utilized for photo-thermal heating of the sample 130 and/or the tip 210.

In some systems, an external arbitrary waveform generator and/or an external data acquisition module (not shown) may be utilized to control testing operations of the sample 130 utilizing the MRD chip 100 and/or measure results. These external modules may be utilized in conjunction with one or more elements of the AFM system 800 or may function independently.

In operation, the AFM computing device 850 may execute instructions that may control configuration of the test set-up in the AFM system 800, perform testing operations and/or control data acquisition via the AFM controller 840, for example. The AFM controller 840 may communicate with the AFM optical system 820, the MRD chip 100 and/or the scanning stage 810 to generate and/or measure various forces and/or changes in properties of the sample 130. The AFM controller may actuate motion of the sample 130 relative to the tip 210 via the scanning stage 810 and/or may read test results as the tip 210 is scanned over the sample surface. The AFM controller 840 may actuate tip 210 and cantilever 220 motion relative to the sample 130, by applying AC and/or DC voltages to the MRD chip 100 and exciting resonant vibrations in one or more of the resonator bars 230 or the continuous resonator membrane 530. The AFM controller 840 and/or the computing device 850 may receive signals from the MRD chip 100 via one or more of the resonator bars 230, the continuous resonator membrane 530 and/or the AFM optical system 820 that may indicate the frequencies of vibration of the tip 210. In this manner, the AFM system 800 may utilize the MRD chip 100 to determine forces and/or changes in properties of the sample 130.

A multi-resonant detection system for atomic force microscopy (AFM) may comprise:

a. an AFM chip;
b. a microcantilever supported by the AFM chip;
c. an AFM tip supported by the microcantilever;
d. either (1) an array of varying-frequency micro-resonators OR (2) a continuous resonance membrane supported by the AFM chip and disposed in an operable relationship with the cantilever so that:

i. at least one of the micro-resonators mechanically amplifies the motion of the microcantilever;

ii. the amplified vibration of the micro-resonator can be read by an atomic force microscope to generate a measurement signal.

iii. (optional) microcantilever can be used as a driver to drive tip motion.

The AFM chip may provide a shield to protect the resonator array from various environmental conditions.

A computing and/or communication system may include one or more computing apparatuses to execute a series of commands representing the method steps described herein. The computing and/or communication system may include a cloud computing environment, which may allow the one or more computing apparatuses to communicate and share information through a wired or wireless network. The one or more computing apparatuses may comprise a mainframe, a super computer, a PC or Apple Mac personal computer, a hand-held device, a smart phone, or any other apparatus having a central processing or controller unit known in the art. Each computing apparatus may be programmed with a series of instructions that, when executed, may cause the computer to perform the method steps as described and claimed in this application. The instructions that are performed may be stored on a machine-readable data storage device and may be carried out by the processing unit or controller.

The machine-readable data storage device may be a portable memory device that may be readable by each computing apparatus. Such portable memory device may be a compact disk (CD), digital video disk (DVD), a Flash Drive, any other disk readable by a disk driver embedded or externally connected to a computer, a memory stick, or any other portable storage medium currently available or yet to be invented. Alternately, the machine-readable data storage device can be an embedded component of a computing apparatus such as a hard disk or a flash drive.

The computing apparatus and machine-readable data storage device can be a standalone device or a device that is imbedded into a machine or other system, such as a cloud, that uses the instructions for a useful result.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for making atomic force microscopy (AFM) measurements, the method comprising the steps of:
in a multi-resonant detection system (MRD) chip comprising an AFM tip, a cantilever, said cantilever mechanically coupled to said AFM tip, and one or more resonator members wherein said one or more resonator members are separately positioned in said MRD chip relative to said cantilever and said AFM tip, one or both of:
detecting a frequency of motion of said AFM tip and said cantilever, by said one or more of said resonator members; and
actuating motion of said AFM tip and said cantilever by said one or more of said resonator members.

2. The method of claim 1, wherein said cantilever is interactively coupled to said one or more resonating members.

3. The method of claim 1, wherein said MRD chip comprises a rigid member which enables said cantilever to oscillate and which is:
coupled to said MRD chip by one or more flexible members,
rigidly coupled to said cantilever, and
mechanically coupled to said one or more one or more resonator members.

4. The method of claim 3, wherein said rigid member, said cantilever and said AFM tip form an armature.

5. The method of claim 4, wherein one or more of said rigid member, said cantilever, said AFM tip and said armature are non-resonating elements of said MRD chip.

6. The method of claim 1, wherein said one or more resonator members comprise one or more of:
an array of discrete resonator bars;
a single resonator bar;
a continuous membrane that can resonate over a continuous range of frequency.

7. The method of claim 1, wherein each of said one or more resonator members resonates at one or more frequency modes to amplify motion of the AFM tip or actuate AFM tip motion.

8. The method of claim 1, wherein said detecting said frequency of said motion of said AFM tip and said cantilever, by said one or more of said resonator members is performed by:
reflecting light from said one or more resonator members to a photo detector at angles determined by displacement of said resonator members; or
detecting said frequency of said motion using an interferometer.

9. The method of claim 1, wherein one or more conductive plates are positioned beneath said one or more resonator members to form one or more capacitors and one or both of:
performing said detecting said frequency of said motion of said AFM tip and said cantilever, by said one or more of said resonator members, based on variations in capacitance resulting from displacement of said one or more resonating members relative to said one or more conductive plates; and
performing said actuating motion of said AFM tip and said cantilever by said one or more of said resonator members by displacing said one or more resonator members utilizing an alternating force created by applying an alternating current (AC) voltage across said one or more conductive plates and said one or more resonator members.

10. The method of claim 1, wherein all or a portion of said one or more resonating members is coated with a piezoelectric or piezo-resistive material and performing one or both of:
said detecting said frequency of motion of said AFM tip and said cantilever utilizing variations in voltage or variations of resistance caused by said displacement of said one or resonant members; and
said actuating said motion of said AFM tip and said cantilever by applying a varying voltage to said one or more resonator members to cause a displacement of said one or more resonator members.

11. The method of claim 1, wherein said one or more resonator members is hermetically encased in one or more cover plates that enable said detecting or said actuating in a liquid medium.

12. The method of claim 1, wherein said multi-resonant detection system (MRD) chip comprising, at least, said AFM tip, said cantilever and said one or more resonator members is fabricated from a wafer utilizing photolithography or machining techniques.

13. A system for making atomic force microscopy (AFM) measurements, the system comprising a multi-resonant detection system (MRD) chip wherein said MRD chip comprises:
an AFM tip,
a cantilever, said cantilever mechanically coupled to said AFM tip; and
one or more resonator members wherein said one or more resonator members are separately positioned in said MRD chip relative to said cantilever and said AFM tip;
wherein said MRD chip is operable to perform one or both of:
detect a frequency of motion of said AFM tip and said cantilever, by one or more of said resonator members; and
actuate motion of said AFM tip and said cantilever by one or more of said resonator members.

14. The system of claim 13, wherein said cantilever is interactively coupled to said one or more resonating members.

15. The system of claim 13, wherein said MRD chip comprises a rigid member which enables said cantilever to oscillate and which is:
coupled to said MRD chip by one or more flexible members,
rigidly coupled to said cantilever, and
mechanically coupled to said one or more one or more resonator members.

16. The method of claim 15, wherein said rigid member, said cantilever and said AFM tip form an armature.

17. The method of claim 16, wherein one or more of said rigid member, said cantilever, said AFM tip and said armature are non-resonating elements of said MRD chip.

18. The system of claim 13, wherein said one or more resonator members comprise one or more of:
an array of discrete resonator bars;
a single resonator bar;
a continuous membrane that can resonate over a continuous range of frequency.

19. The system of claim 13, wherein each of said one or more resonator members resonates at one or more frequency modes to amplify motion of the AFM tip or actuate AFM tip motion.

20. The system of claim 13, wherein said detecting said frequency of said motion of said AFM tip and said cantilever, by said one or more of said resonator members is performed by:
reflecting light from said one or more resonator members to a photo detector at angles determined by displacement of said resonator members; or
detecting said frequency of said motion using an interferometer.

21. The system of claim 13, wherein one or more conductive plates are positioned beneath said one or more resonator members to form one or more capacitors and one or both of:
performing said detecting said frequency of said motion of said AFM tip and said cantilever, by said one or more of said resonator members, based on variations in capacitance resulting from displacement of said one or more resonating members relative to said one or more conductive plates; and
performing said actuating motion of said AFM tip and said cantilever by said one or more of said resonator members by displacing said one or more resonator members utilizing an alternating force created by applying an alternating current (AC) voltage across said one or more conductive plates and said one or more resonator members.

22. The system of claim 13, wherein all or a portion of said one or more resonating members is coated with a piezoelectric or piezo-resistive material and performing one or both of:
said detecting said frequency of motion of said AFM tip and said cantilever utilizing variations in voltage or variations of resistance caused by said displacement of said one or resonant members; and
said actuating said motion of said AFM tip and said cantilever by applying a varying voltage to said one or more resonator members to cause a displacement of said one or more resonator members.

23. The system of claim 13, wherein said one or more resonator members is hermetically encased in one or more cover plates that enable said detecting or said actuating in a liquid medium.

24. The system of claim 13, wherein said MRD chip comprising, at least, said AFM tip, said cantilever and said one or more resonator members is fabricated from a wafer utilizing photolithography or machining techniques.
